(19) United States
(12) Patent Application Publication
(10) Pub. No.: US 2011/0202301 A1
(43) Pub. Date: Aug. 18, 2011

(54) MIDDLEWARE TEST COMPONENT OPERATING METHOD AND DEVICE

(75) Inventors: Jun Sik Kim, Kyungki-do (KR); Nam Hoon Park, Daejeon (KR)

(73) Assignee: ELECTRONICS AND TELECOMMUNICATIONS RESEARCH INSTITUTE, DAEJEON (KR)

(21) Appl. No.: 12/808,877

(22) PCT Filed: Sep. 11, 2008
(86) PCT No.: PCT/KR2008/005372

§ 371 Date: Jun. 17, 2010

(30) Foreign Application Priority Data
Dec. 17, 2007 (KR) 10-2007-0132824

(51) Int. Cl. G06F 19/00

(52) U.S. Cl. 702/108

(57) ABSTRACT

The present invention relates to middleware test component operating method and device. It is possible to improve the system capacity and the efficiency of an SDR (Software Defined Radio) system through the reconfiguration of the system according to a user's request by reconfiguring a test component for the capacity measurement of installation and test of a software component and capacity measurement of the communication port using the SDR system in a wireless communication system.

### TECHNICAL FIELD

The present invention relates to a middleware test component operating method and device that reconfigures a system according to a user's request using an SDR (Software Defined Radio) system in a wireless communication system and accordingly improves the capacity of the system.

This work was partly supported by the IT R & D program of MIC/IITA [2006-S-012-02, ‘Development of Middleware Platform for Software Defined Radio (SDR) Terminal’].

### BACKGROUND ART

The improvement of mobile communication technologies has promoted the use of wireless data, broadcasts, and interne services, and accordingly, service providers have been providing various types of wireless broadcasts and data services. In particular, a diversity of wireless data services, which can be selected by users, expanded needs of multi mode systems, and this raised the value of SDR (Software Defined Radio) system that can meet such needs.

Wireless broadcasts and data services are provided in a number of ways and theses services are different from one another in coverage, use, and costs. And the same services may be provided in various radio access methods in the same site. Therefore, it is necessary to allow users to select data services through an appropriate radio access method conforming to their use including mobile communication.

A current dual mode or multi mode system has a radio access modem and the related program embedded therein and changes its radio access modes according to user's use. Therefore, it basically eliminates a need of software download; in fact, software download is performed only for error correction, service addition, paid service addition, or software upgrade. Also, even if software needs to be upgraded, such upgrading should be carried out by wires in a specific store that provides such an upgrade service. From time to time, paid application services, such as computer games, can be partially downloaded wirelessly, but it is limited only to specific download services.

On the contrary, an SDR system has been basically designed to be capable of providing radio access services by downloading radio access related software. Therefore, the radio access related software is provided based on components, and user may receive radio access services by downloading wirelessly, by wires, or by storage, software components for supporting a radio access method appropriate for user's use.

Upon application of SCA (Software Communication Architecture) middleware recommended as standard for SDR systems, CORBA-based communication ports should be used between application components. While the software to implement communication protocol pursues high speed, the system implementation by middleware has a merit in that the software is standardized, but suffers from relative reduction in speed. Therefore, such a reduction in speed acts as an obstacle in applying the SDR platform to a communication system targeted for high rate data process.

Also, the implementation of communication protocol by the component based software causes the configuration and operation to be complicated and difficult compared with existing communication software.

The SDR system is basically operated based on components, and therefore, the operation and management of the components are a technical issue that should be handled critically. These operation and management may be divided into an initial configuration and alteration of radio access mode, and operations associated with maintenance, and these require a test method for determining whether software components are installed properly upon installation and operation since the services and configurations are modified by the alteration of the software. Also, these operation and management require a device of monitoring the state of a system configured with SDR upon testing and examining of initial middleware.

Furthermore, since next generation wireless communication systems are expected to discriminately provide high-rate and low-rate services, operational methods for such wireless communication systems are required.

### DISCLOSURE OF INVENTION

### Technical Problem

An object of the present invention is to provide middleware test component operating method and device capable of improving the efficiency of an SDR system and allowing for various types of radio accesses with a single hardware without any modification of the hardware to provide a user with wireless data services selected by a user's request, by configuring and operating a test component for installation and test, and measuring the capacity of a communication port, so that the user has an access to a wireless network through a current service is provided through an SDR system and efficiently receives data services.

### Technical Solution

To accomplish the above object, a middleware test component operation method according to the present invention includes: configuring a test component when a radio access means is initially driven; testing each component retained using the configured test component; collecting data generated during the test to generate a test result; and outputting the test result.

A device having a middleware test component according to the present invention includes: a test component configured to test a middleware, wherein the test component includes: a capacity monitoring unit monitoring a capacity by detecting a flow of data in a system; a statistical information processor collecting and outputting resultant data generated during a test; and a configuration management unit setting a function of a component corresponding to inputted data, performing a test including an interface between components to enable a capacity of the component to be measured through the capacitor monitoring unit, and enabling a test result to be outputted through the statistical information processor.

### Advantageous Effects

The middleware test component operating method and device according to the present invention may easily install a component in the SDR (Software Defined Radio) system and test the component, monitor the state of the system, provide an efficient wireless data services by reconfiguring the SDR system by a user's request, allow for various radio accesses with a single terminal without any modification of the hardware by enabling the radio access modules for multi-mode services to be reconfigured only by modification of software, and improve the utility and user convenience.

### BRIEF DESCRIPTION OF THE DRAWINGS

FIG. 1 is a view illustrating a wireless network configuration according to an exemplary embodiment of the present invention.

FIG. 2 is a view illustrating a configuration of an SDR terminal according to an exemplary embodiment of the present invention.

FIG. 3 is a block diagram illustrating a configuration of an SDR software component module according to an exemplary embodiment of the present invention.

FIG. 4 is a view illustrating a configuration of a test component according to an exemplary embodiment of the present invention.

FIG. 5 is a flowchart illustrating an operation related to a test component configuration and its operation method according to an exemplary embodiment of the present invention.

### BEST MODE FOR CARRYING OUT THE INVENTION

Hereinafter, exemplary embodiments of the present invention will be described in more detail with reference to accompanying drawings.

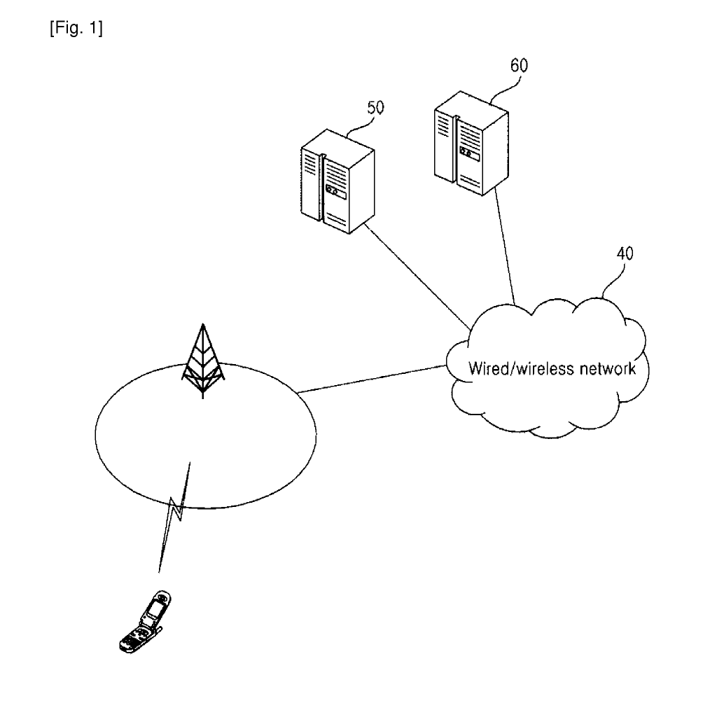

FIG. 1 is a view illustrating a wireless network configuration according to an exemplary embodiment of the present invention.

Referring to FIG. 1, the wireless network to which a middleware test component system of the present invention is applied includes a terminal 10 having an SDR (Software Defined Radio) middleware and a base station 30 having an SDR middleware and providing the terminal 10 with a wireless access network.

The wireless network is connected to a wired/wireless network 40 connected to the Internet and having an authentication sensor 60 and a download center 50 providing a software component, so that the wireless network may provide data services to the terminal 10.

The terminal 10 transmits/receives data to/from the base station 30 through wireless access, and the base station 30 is connected to the wired/wireless network 50 by wires. SDR may be applied to both the terminal 10 and the base station 30, or may be applied to either of the terminal 10 or base station 30 like existing devices.

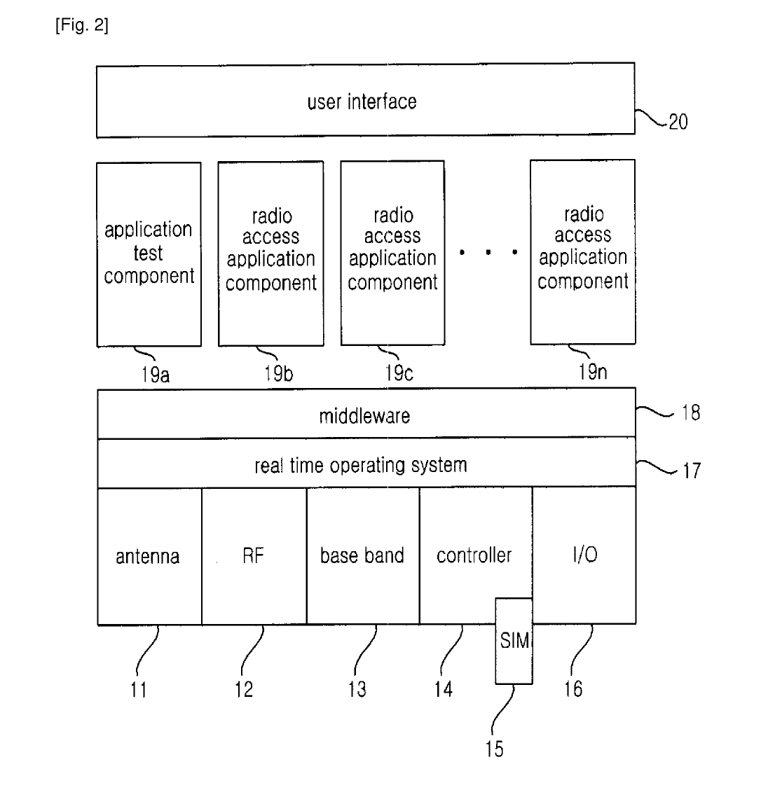

FIG. 2 is a view illustrating a configuration of an SDR terminal according to an exemplary embodiment of the present invention.

Referring to 2, the terminal 10 includes an antenna 11 for wireless access, an RF (Radio Frequency) unit 12 for handling wireless signals, and a base band unit 13. The terminal 10 further includes a subscriber identification module (SIM) 15 storing subscriber identification information, a controller 14 having a universal processor, and an input/output (I/O) interface 16 for input and output. The 15 may be configured to be detachable and provides a connection through a standard interface.

The 16 is included in the terminal to perform data I/O with external devices (not shown). For example, the 16 includes a universal interface, such as USB and PCMCIA. The 16 may be provided as LAN or wireless LAN in the environment of a notebook computer or PDA.

The terminal 10 downloads a wireless map and an initial driving radio access software component through the 16, and in case that it is difficult to wirelessly download them, the 10 is used for download by wires or other devices.

The 10 has the hardware configured as above, and a real time operating system 17 for terminal operation and a middleware 18 for efficient SDR operation are installed in the hardware.

The 18 includes a test component and plural radio access components 19a to 19n that reside in a fixed memory of the 10 to drive radio access components for providing a service selected by a user through a user interface 20 and perform a wireless access. The 18 drives and operates the test component.

The test component is configured using a specific radio access component according to a basic system configuration or user command entered through the user interface 20.

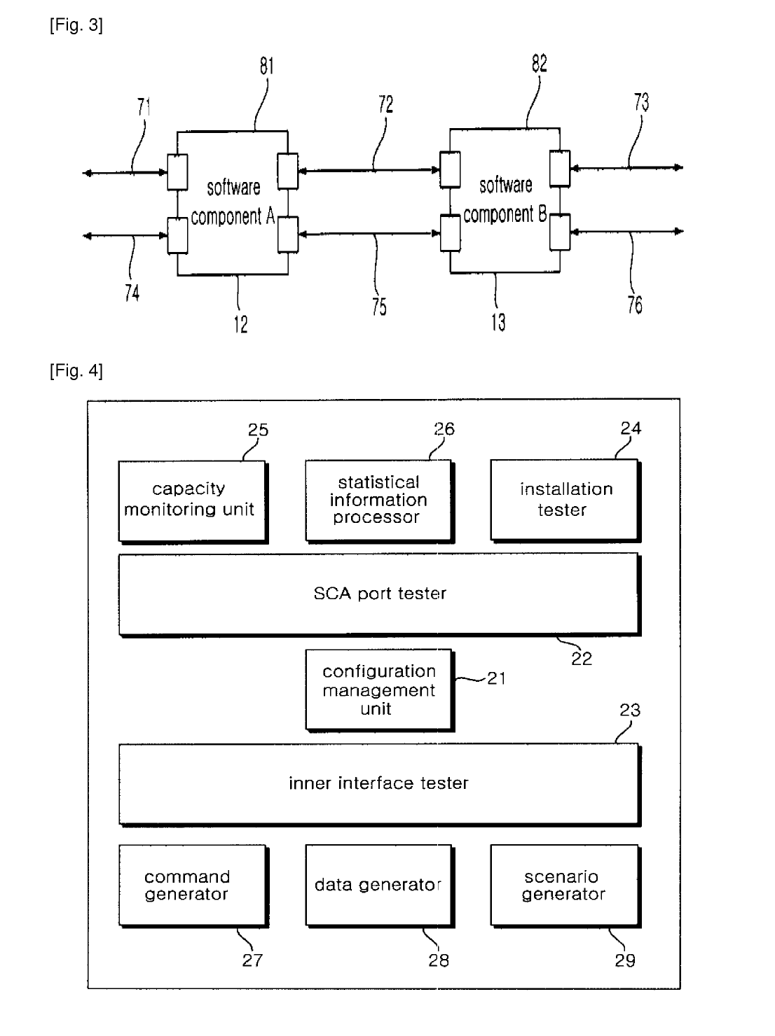

FIG. 3 is a block diagram illustrating a configuration of an SDR software component module according to an exemplary embodiment of the present invention.

Referring to FIG. 3, software components 81 and 82 provided from the network provide ports 71 to 73 and inner interfaces 74 to 76 specified in the standard for each component as an inter-component communication scheme. The ports 71 to 73 should conform to the standard and communicates with the middleware and other software components through CORBA communication in a standardized scheme.

The term CORBA refers to a common standard for object request broker (ORB) that brokers communication between objects in a distributed system environment. A CORBA service contains 18 items as a basic service function provided to the objects through the CORBA.

The inner interface 74 to 76 is a communication scheme provided together with configuration information upon designing components. The inner interface 74 to 76 is designed to raise recycling ratio of software and enable high-speed interfacing. The inner interface 74 to 76 has an inner interface form such as IPC (Inter Process Communication).

The components that perform communication using the inner interfaces 74 to 76 are integrated as a single component on the middleware.

FIG. 4 is a view illustrating a configuration of a test component according to an exemplary embodiment of the present invention.

The test component includes plural functional blocks, each performing a predetermined function. Referring to FIG. 4, the test component includes a configuration management unit 21, an SCA (Software Communication Architecture) port tester 22, an inner interface tester 23, an installation tester 24, a capacity monitoring unit 25, a statistical information processor 26, a command generator 47, a data generator 28, and a scenario generator 29.

The test component is driven and operated by the 18.

The 21 sets functions of the components corresponding to data inputted through the 20. The 21 performs testing and interfacing between components, and measures the capacity of each component.

Upon testing the components, the 21 targets interfacing between components as its main object to be tested, and, in case that the component interface provides an SCA port on an SCA system, the 21 tests the SCA port through the 22

In case of using the software inner interface, the 21 sets the 23 and enables the 23 to operate.

Upon proceeding with an installation test through the 18, the 21 executes the 24 on the component and controls the 27, the 28, and the 29 retained on the component to input and output prescribed information in order to test connection between the components.

Upon testing whether the system normally operates during an operation, the 41 performs the test by controlling data to be bypassed.

The 25 starts to run to measure the capacity, and detects the flow of data sensed on the interface. The 26 controls the output so that the sensed data may be provided to the user.

Hereinafter, an operation of the system configured above will be described according to an exemplary embodiment of the present invention.

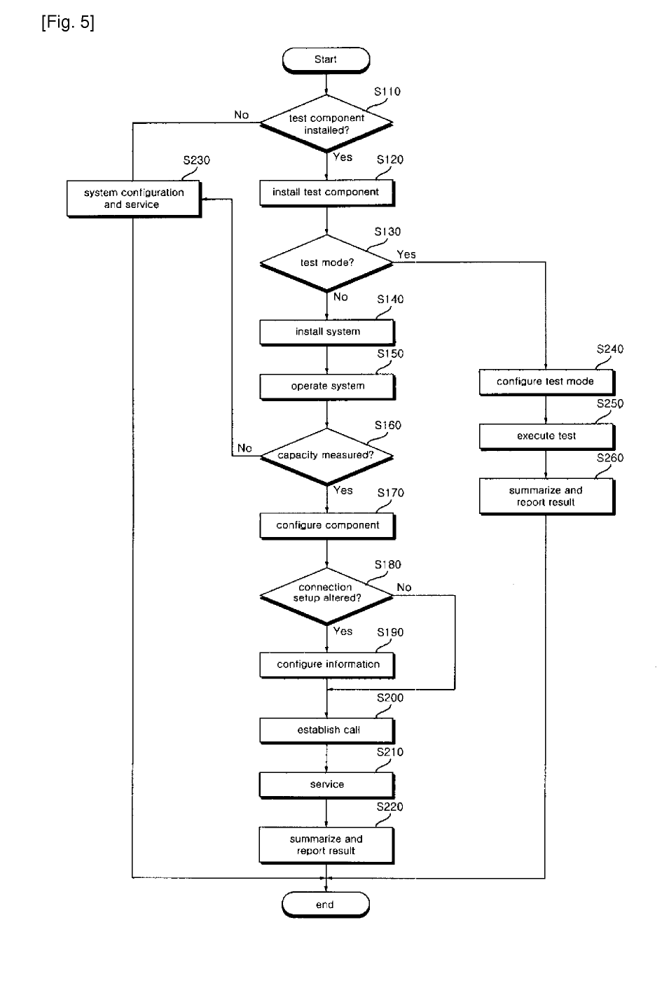

FIG. 5 is a flowchart illustrating an operation related to a test component configuration and its operation method according to an exemplary embodiment of the present invention.

Referring to FIG. 5, if the 12 for radio access is initially driven, it is determined whether the test component is installed (step S110).

If it is determined that the test component is not installed, an existing SDR system configuration and installation procedure is performed (step S230).

If it is determined that the test component is installed, the test component is installed on the system (step S120). An initial setup for the test component is performed.

If the test component is set up in a test mode (step S130), a test mode is configured for the interface and data flow test (step S240) and the test component is executed to start a test (step S250).

If the test is complete, the result of the test is summarized and reported (step S260). The test performed as above is a test according to call process or a test for software in the test environment. The results collected during the test may be received through the 26 without any treatment to the data, or with the data processed in a desired format.

The test results are outputted through the user interface so that the user may identify them.

If the test component is not set up in test mode (step S130), a system installation procedure and a system operation procedure start for preparation of service initiation (steps S140 and S150). The test component is operated in a bypass mode.

If a capacity measurement is requested according to a user's command (step S160), a component is configured for capacity measurement (step S170), and it is determined whether the connection setup between components needs to be changed (step S180). In case that it is determined that the connection setup needs to be changed, a modification procedure is performed (step S190), a call is established (step S200), and then a service starts (step S210). In case that it is determined that the connection setup need not be changed, the call is established (step S200) and the service starts (step s210) without such a separate modification procedure.

The data collected through the service are outputted so that the user may identify it through a prescribed procedure, and the result of the operation is reported (step S220).

Accordingly, the middleware test component and its operation method may efficiently operate the components and improve the utilization and capacity by reconfiguring the test component as necessary to perform a test and a capacity measurement for the components.

The foregoing embodiments and advantages are merely exemplary and are not to be construed as limiting the present invention. The present teaching can be readily applied to other types of apparatuses.

The description of the foregoing embodiments is intended to be illustrative, and not to limit the scope of the claims. Many alternatives, modifications, and variations will be apparent to those skilled in the art.

### INDUSTRIAL APPLICABILITY

The middleware test component operation method and its device according to the present invention may reconfigure the SDR system according to a user's request, and therefore, provide an efficient wireless data service. In addition, the middleware test component operation method and its device according to the present invention may reconfigure the radio access module for multi mode service only by modifying the software, and therefore, provide various radio access methods with a single terminal without modification of hardware.

1. A middleware test component operation method comprising:
configuring a test component when a radio access means is initially driven;
testing each component retained using the configured test component;
collecting data generated during the test to generate a test result; and
outputting the test result.

2. The middleware test component operation method of claim 1, wherein said configuring the test component,
configuring the test component using a prescribed radio access component according to an inputted user command or system configuration.

3. The middleware test component operation method of claim 1, wherein said testing each component,
testing a port of a component interface between retained plural components.

4. The middleware test component operation method of claim 1, wherein said testing each component,
generating prescribed data and a prescribed message in the test component and testing a setup state of the component through the generated data and message.

5. The middleware test component operation method of claim 4, wherein said testing each component,
performing a test according to an input/output state of the generated data and message by executing a command generator, a data generator, and a scenario generator included in the test component.

6. The middleware test component operation method of claim 4, wherein said testing each component,
testing a normal operation by bypassing the data and message in case that it is not required to separately generate the data and message.

7. The middleware test component operation method of claim 1, further comprising:
measuring a capacity by detecting a flow of data in an interface using the test component.

8. The middleware test component operation method of claim 7, further comprising:
outputting a result of the capacity measurement.

9. A device having a middleware test component comprising:
a test component configured to test a middleware, wherein
the test component comprises:
a capacity monitoring unit monitoring a capacity by detecting a flow of data in a system;
a statistical information processor collecting and outputting resultant data generated during a test; and
a configuration management unit setting a function of a component corresponding to inputted data, performing a test including an interface between components to enable a capacity of the component to be measured through the capacitor monitoring unit, and enabling a test result to be outputted through the statistical information processor.

10. The device of claim 9, further comprising:
an SCA port tester testing a capacity of a port provided by a component interface; and
an inner interface tester testing an inner interface of a software, wherein the configuration management unit enables a test to be proceeded through the SCA port tester and the inner interface tester by targeting an interface between components as a main object to be tested upon performing a component test.

11. The device of claim 9, further comprising:
an installation tester testing a normal installation on an installed component;
a command generator provided on a component to generate a command;
a data generator generating data of a component; and
a scenario generator for a component operation, wherein
the configuration management unit controls the command generator, the data generator, and the scenario generator so that prescribed data are inputted/outputted, test a connection between components according to inputted/outputted data, controls the installation tester, and tests an installation state of the component.

12. The device of claim 9, wherein
the configuration management unit enables data to be bypassed to perform a test operation, upon testing a normal operation of a system operation through the capacity monitoring unit.
